(19) United States
(12) Patent Application Publication
(10) Pub. No.: US 2009/0184441 A1
(43) Pub. Date: Jul. 23, 2009

(54) Microstructure roller, microstructure fabrication method, tool for fabricating a microstructure roller

(76) Inventors: Sen-Yeu Yang, Taipei (TW); Chih-Yuan Chang, Taipei (TW); Ming-Hui Chu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,980

(22) Filed: Jan. 14, 2009

(30) Foreign Application Priority Data
Jan. 18, 2008 (TW) 097101961

(51) Int. Cl. B29C 33/42; B28B 21/04

(52) U.S. Cl. 264/316; 425/465

(57) ABSTRACT

A microstructure roller formed of a cylinder and a resin pattern layer is disclosed. The microstructure roller is made by: providing a cylinder having a groove extending around the periphery, and then adhering a flexible mold plate to the periphery of the cylinder to have a cavity be defined in between the groove of the cylinder and a patterned face of microstructure patterns of the flexible mold plate, and then filling a resin in the cavity, and the curing the resin, and then removing the flexible mold plate from the cylinder.

### BACKGROUND OF THE INVENTION

The present invention relates to roller technology and more particularly, to a microstructure roller, the fabrication of such a microstructure roller and, tool for fabricating the microstructure roller.

Following fast development of photoelectric technology, optical devices for photoelectric products may be made micro-sized in an arrayed design, forming a micro optical component array. Excimer laser micromachining technology of LIGA-like process, semiconductor manufacturing process or etching technology may be employed for fabricating micro optical components. However, the equipment cost of these conventional manufacturing methods is high. Further, these conventional processes are complicated and requiring much labor and time.

Some manufacturers employ roller imprinting or transfer printing technique to fabricate micro optical components. FIGS. 1A˜1C illustrate the manufacturing flow of the fabrication of a microstructure roller according to the prior art. According to this method, the microstructure roller fabrication method comprises the step of forming a protective metal layer 12 on a steel roller 10 and then forming a mask 14 on the protective metal layer 12 at selected locations (see FIG. 1A), and then etching the protective metal layer 12 and the steel roller 10 corresponding to the area beyond the mask 14 to form the desired notches 16 (see FIG. 1B), and then removing the mask 14 and the protective metal layer 12 from the steel roller 10, finishing the fabrication of a microstructure roller 10 carrying the desired notches 16 (see FIG. 1C).

However, an etching equipment is quite expensive. Further, it is very difficult to etch notches on an object subject to the designed shape and depth. Performing a precision etching step on the surface of a cylindrical member is more difficult to achieve. Further, the solvent used during etching is strongly toxic, putting the operator and the environment in danger.

### SUMMARY OF THE PRESENT INVENTION

It is, therefore, the primary object of the present invention to provide a microstructure roller fabrication method, which uses a flexible mold plate carrying an array of microstructure patterns for the formation of the desired microstructure accurately.

It is another object of the present invention to provide a microstructure roller fabrication method, which cures resin to form the desired microstructure patterns, simplifying the fabrication and lowering the manufacturing cost.

It is still another object of the present invention to provide a microstructure roller fabrication method, which enables the array of microstructure patterns to be selectively made in the form of an array of micro grid male dies, an array of micro color filter male dies, an array of micro diffuser male dies, an array of micro brightness enhancing structure male dies or an array of micro spacer male dies for making different micro optical devices.

It is still another object of the present invention to provide a tool for fabricating microstructure rollers, which uses a flexible mold plate carrying an array of microstructure patterns for the formation of the desired microstructure accurately.

It is still another object of the present invention to provide a tool for fabricating microstructure rollers, which provides a cylinder having a groove extending around the periphery for the filling of a resin to form a resin pattern layer carrying an array of microstructure patterns.

It is still another object of the present invention to provide a microstructure roller, which has a resin pattern layer carrying an array of microstructure patterns for making micro optical devices by means of a rolling impression technique or a roller imprinting technique

To achieve these and other objects of the present invention, the microstructure roller fabrication method comprises the steps of: providing a flexible mold plate having a patterned face that carries an array of microstructure patterns; providing a cylinder, which comprises an axial hole and a groove extending around the periphery thereof; adhering the patterned face of the flexible mold plate to the periphery of the cylinder to have a cavity be defined in the groove between the cylinder and the flexible mold plate; providing a resin; applying the resin to fill up the cavity; curing the resin in the cavity; and removing the flexible mold plate from the cylinder.

To achieve these and other objects of the present invention, the tool for making a microstructure roller comprises a flexible mold plate having a patterned face that carries an array of microstructure patterns, and a cylinder, which comprises an axial hole and a groove extending around the periphery thereof. The patterned face of the flexible mold plate is adhered to the periphery of the cylinder to have a cavity be defined in the groove between the cylinder and the flexible mold plate.

To achieve these and other objects of the present invention, the microstructure roller comprises a cylinder, which comprises an axial hole and at least one groove extending around the periphery thereof, and a resin pattern layer embedded in the at least one groove of the cylinder and carrying an array of microstructure patterns on the surface thereof.

### BRIEF DESCRIPTION OF THE DRAWINGS

FIGS. 1A˜1C illustrate the manufacturing flow of the fabrication of a microstructure roller according to the prior art.

FIGS. 2˜4 illustrate the manufacturing flow of the fabrication of a microstructure roller according to the present invention.

FIG. 5 is a schematic drawing showing the fabrication of a micro optical device through a rolling impression technique according to the present invention.

FIG. 6 is a schematic drawing showing the fabrication of a micro optical device through a roller imprinting technique according to the present invention.

FIG. 7 is an elevational view of two flexible mold plates of different male die patterns prepared according to the present invention.

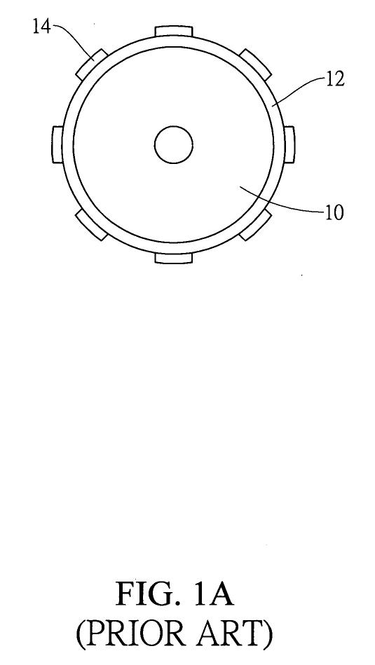

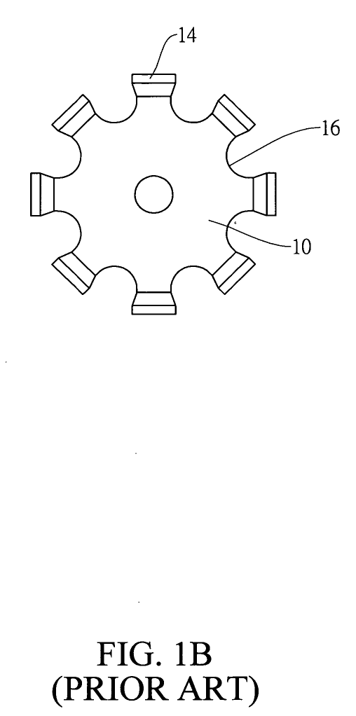

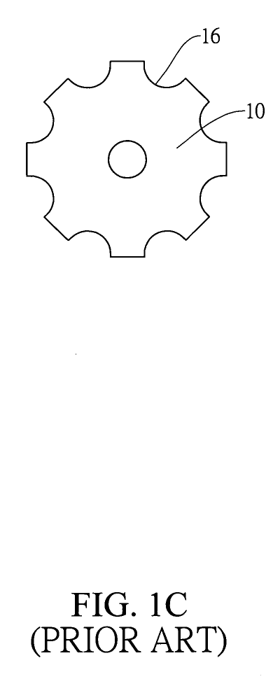

### DETAILED DESCRIPTION OF THE PREFERRED EMBODIMENTS

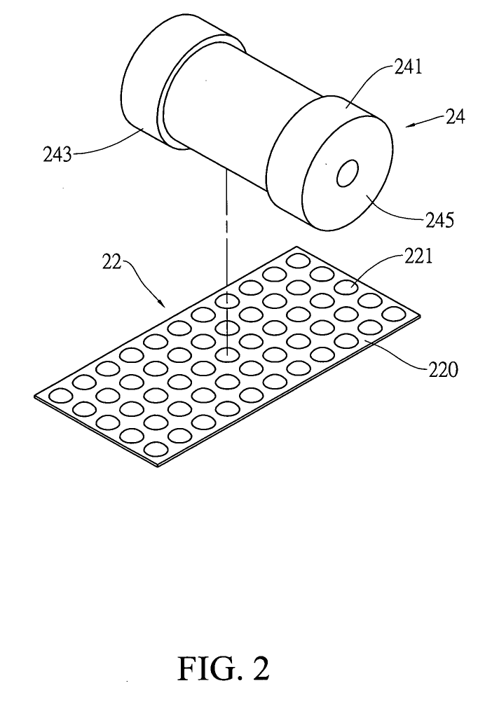

Please refer to FIGS. 2˜4, a microstructure roller fabrication method for fabricating a microstructure roller in accordance with one example of the present invention is shown comprising, at first, the step of preparing a flexible mold plate 22 and a cylinder 24 (see FIG. 2). The flexible mold plate 22 has an array of micro lens male dies 221 arranged on its one side, forming a patterned face 220. The cylinder 24 has an axial hole 245, and a groove 243 extending around the periphery 241.

The patterned face 220 of the flexible mold plate 22 is then adhered to the periphery 241 of the cylinder 24 so that a cavity is defined in between the flexible mold plate 22 and the groove 243. Thereafter, a prepared resin 30 is filled in the cavity in between the flexible mold plate 22 and the groove 243, and then cured (see FIG. 3). After the resin 30 is cured, remove the flexible mold plate 22 from the cylinder 24, and the desired microstructure roller 20 is thus obtained (see FIG. 4). The finished microstructure roller 20 comprises the aforesaid cylinder 24, and a resin pattern layer 32, which is embedded in the groove 243 of the cylinder 24 and carries an array of micro lens female dies 321.

The aforesaid flexible mold plate 22 can be a thin plate prepared from stainless steel, nickel, polycarbonate, or polyethylene terephthalate. The patterned face 220 according to the present preferred embodiment comprises an array of micro lens male dies 221. Alternatively, the patterned face 220 can be made having an array of micro grid male dies, micro color filter male dies, micro diffuser male dies, micro brightness enhancing structure male dies or micro spacer male dies.

Because the flexible mold plate 22 can be spread into a plane, the facial microstructure of the flexible mold plate 22 can easily be processed by means of known matured techniques, saving the cost and assuring high precision.

The cylinder 24 can be made of glass, plastics, silicon rubber, or any of a variety of metal materials. Further, the resin 30 can be a thermosetting resin or photocurable resin.

The resin curing (hardening) step to be employed during the fabrication of the microstructure roller is determined subject to the type of resin used. When a thermosetting resin is used, a heating step is employed to cure the resin. If a photocurable resin is used, an ultraviolet radiation step is employed to cure the photocurable resin.

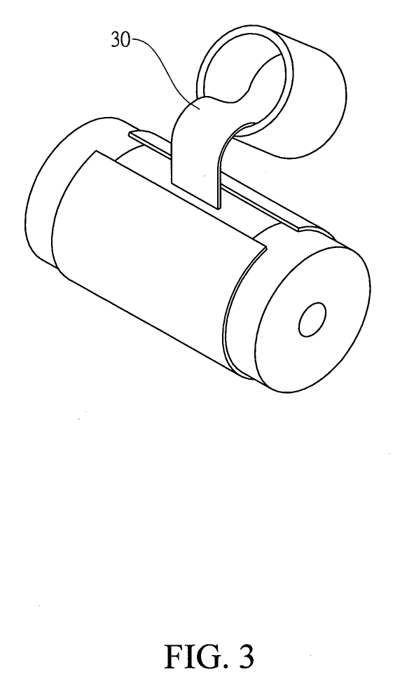

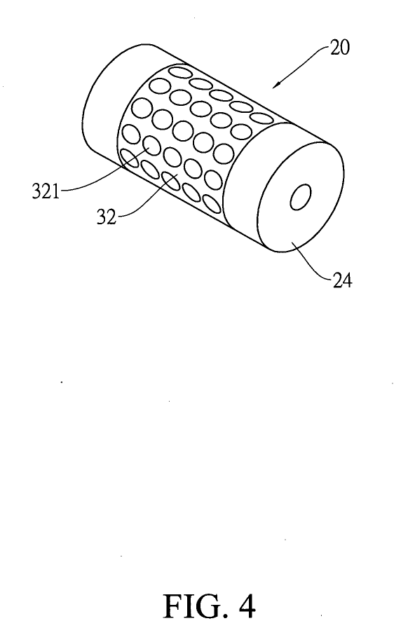

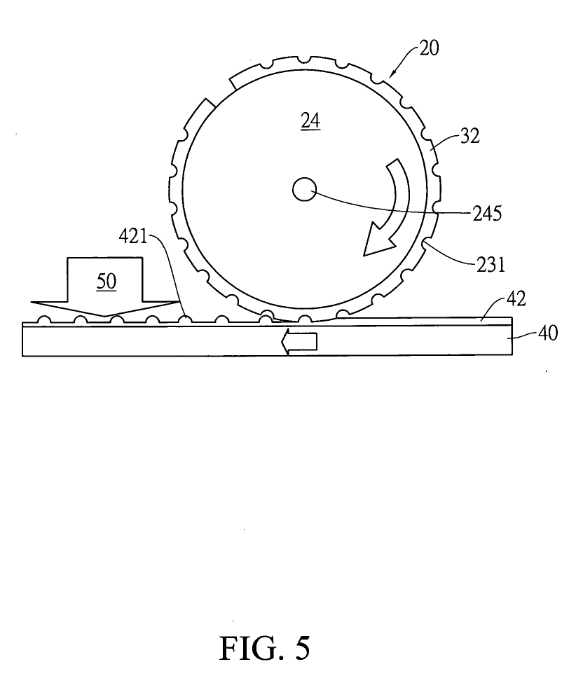

FIG. 5 is a schematic drawing showing the fabrication of a micro optical device through a rolling impression technique according to the present invention. As illustrated, a microstructure roller 20 prepared according to the present invention is used for fabricating a micro optical device by means of a rolling impression technique.

At first, select a substrate 40 and then coat the substrate 40 with a resin layer 42. Thereafter, select a microstructure roller 20 prepared according to the present invention. According to this micro optical device fabrication example, the microstructure roller 20 comprises a resin pattern layer 32 carrying an array of micro lens female dies 321.

The selected microstructure roller 20 is rotated over the resin layer 42 on the substrate 40 to impress the resin layer 42, causing formation an array of micro lens 421 in the resin layer 42 corresponding to the micro lens female dies 321 of the resin pattern layer 32 of the microstructure roller 20.

Thereafter, apply a heating process (or ultraviolet light radiation subject to the nature of the resin used) to cure the impressed resin layer, finishing the fabrication of the array of micro lens 421.

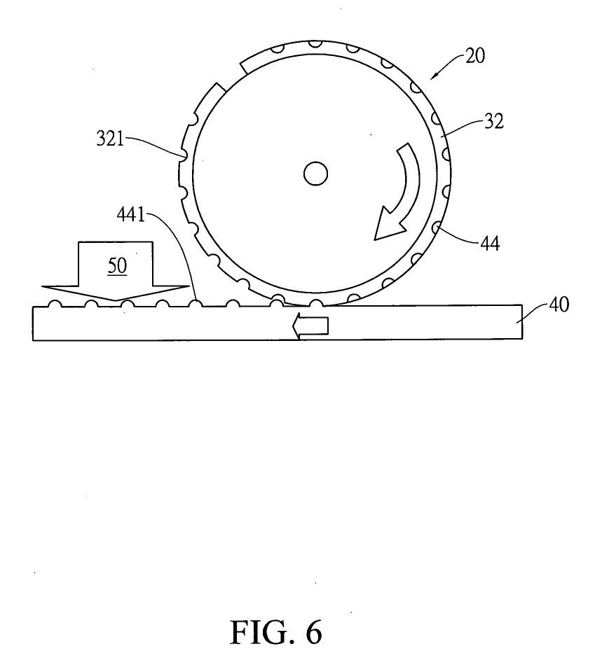

FIG. 6 is a schematic drawing showing the fabrication of a micro optical device through a roller imprinting technique according to the present invention. As illustrated, a microstructure roller 20 prepared according to the present invention is used for fabricating a micro optical device by means of a rolling imprinting technique.

At first, select a substrate 40 and a microstructure roller 20. According to this micro optical device fabrication example, the microstructure roller 20 comprises a resin pattern layer 32 carrying an array of micro lens female dies 321.

Thereafter, apply a resin 42 to the microstructure roller 20 to fill up the micro lens female dies 321 of the resin pattern layer 32 with the resin 42, and then roll the microstructure roller 20 over the surface of the substrate 40 to transfer-print the resin 42 from the micro lens female dies 321 onto the surface of the substrate 40, thereby forming an array of micro lenses 441 on the substrate 40.

Thereafter, apply a heating process (or ultraviolet light radiation subject to the nature of the resin used) to cure the impressed resin layer, finishing the fabrication of the array of micro lens 441.

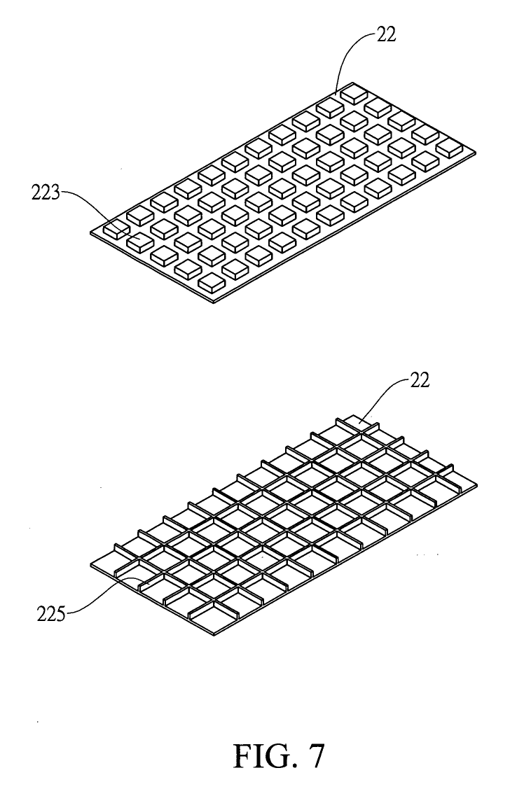

Referring to FIG. 7, flexible mold plates of different male die patterns may be selected used for making rollers of different microstructures. One flexible mold plate is shown carrying an array of micro lens color filter male dies 223. The other flexible mold plate is shown carrying an array of micro spacer male dies 225. In conclusion, a flexible mold plate can be made having any of a variety of microstructure patterns.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A microstructure roller fabrication method, comprising the steps of:
providing a flexible mold plate, said flexible mold plate comprising a patterned face, said patterned face comprising an array of microstructure patterns;
providing a cylinder, said cylinder comprising an axial hole, and a groove extending around the periphery thereof;
adhering said patterned face of said flexible mold plate to the periphery of said cylinder to have a cavity be defined in said groove between said cylinder and said flexible mold plate;
providing a resin;
applying said resin to fill up said cavity;
curing said resin in said cavity; and
removing said flexible mold plate from said cylinder.

2. The microstructure roller fabrication method as claimed in claim 1, wherein said resin is selected from a material group of thermosetting resins and photocurable resins.

3. The microstructure roller fabrication method as claimed in claim 2, wherein the step of curing said resin in said cavity is to apply one of a thermal curing technique and a photo curing technique subject to the resin material selected.

4. The microstructure roller fabrication method as claimed in claim 1, wherein said cylinder is selected from a group of glass cylinder, plastic cylinder, silicon rubber cylinder and metal cylinder.

5. The microstructure roller fabrication method as claimed in claim 1, wherein said flexible mold plate is prepared from one of the material group of stainless steel, nickel, polycarbonate and polyethylene terephthalate.

6. The microstructure roller fabrication method as claimed in claim 1, wherein said array of microstructure patterns is one of an array of micro grid male dies, an array of micro color filter male dies, an array of micro diff-user male dies, an array of micro brightness enhancing structure male dies and an array of micro spacer male dies.

7. The microstructure roller fabrication method as claimed in claim 2, wherein said resin is a thermosetting resin, and the step of curing said resin in said cavity is to apply a thermal curing technique to cure said resin when said resin.

8. The microstructure roller fabrication method as claimed in claim 2, wherein said resin is a photocurable resin, and the step of curing said resin in said cavity is to apply a photo curing technique to cure said resin when said resin.

9. A tool for making a microstructure roller, comprising:
a flexible mold plate, said flexible mold plate comprising a patterned face, said patterned face comprising an array of microstructure patterns; and
a cylinder, said cylinder comprising an axial hole, and a groove extending around the periphery thereof;
wherein said patterned face of said flexible mold plate is adhered to the periphery of said cylinder to have a cavity be defined in said groove between said cylinder and said flexible mold plate.

10. The tool for making a microstructure roller as claimed in claim 9, wherein said cylinder is selected from a group of glass cylinder, plastic cylinder, silicon rubber cylinder and metal cylinder.

11. The tool for making a microstructure roller as claimed in claim 9, wherein said flexible mold plate is prepared from one of the material group of stainless steel, nickel, polycarbonate and polyethylene terephthalate.

12. The tool for making a microstructure roller as claimed in claim 9, wherein said array of microstructure patterns is one of an array of micro grid male dies, an array of micro color filter male dies, an array of micro diffuser male dies, an array of micro brightness enhancing structure male dies and an array of micro spacer male dies.

13. A microstructure roller comprising:
a cylinder, said cylinder comprising an axial hole, and at least one groove extending around the periphery thereof; and
a resin pattern layer embedded in said at least one groove of said cylinder, said resin pattern layer carrying an array of microstructure patterns on a surface thereof.

14. The microstructure roller as claimed in claim 13, wherein said resin pattern layer is prepared from one of a thermosetting resin and a photocurable resin.

15. The microstructure roller as claimed in claim 13, wherein said cylinder is selected from a group of glass cylinder, plastic cylinder, silicon rubber cylinder and metal cylinder.

16. The microstructure roller as claimed in claim 13, wherein said array of microstructure patterns is one of an array of micro grid male dies, an array of micro color filter male dies, an array of micro diffuser male dies, an array of micro brightness enhancing structure male dies and an array of micro spacer male dies.
